(19) United States
(12) Patent Application Publication
(10) Pub. No.: US 2008/0174918 A1
(43) Pub. Date: Jul. 24, 2008

(54) METHOD AND SYSTEM FOR WRITING AND READING A CHARGE-TRAP MEDIA WITH A PROBE TIP

(75) Inventor: Byong Man Kim, Fremont, CA (US)

Correspondence Address: FLIESLER MEYER LLP, 650 CALIFORNIA STREET, 14TH FLOOR, SAN FRANCISCO, CA, 94108, US

(73) Assignee: Nanochip, Inc., Fremont, CA (US)

(21) Appl. No.: 11/625,221

(22) Filed: Jan. 19, 2007

(51) Int. Cl. G11B 5/54

(52) U.S. Cl. 360/250

(57) ABSTRACT

An embodiment of a system for storing information in accordance with the present invention comprises a media including a barrier layer, an isolation layer and a trapping layer disposed between the barrier layer and the isolation layer; and a tip adapted to inject a charge through the barrier layer and into the trapping layer.

### TECHNICAL FIELD

This invention relates to systems for storing information.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Add to this need for capacity, the confluence of personal computing and consumer electronics in the form of personal MP3 players, such as iPod®, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and its therefore sparingly used. Consequently, there is a need for solutions which permit higher density data storage at a reasonable cost per megabyte.

### BRIEF DESCRIPTION OF THE DRAWINGS

Further details of the present invention are explained with the help of the attached drawings in which:

FIG. 1 is an embodiment of a cross-section of a system for storing information in accordance with the present invention including a media device and a tip positioned in proximity to the media for injecting a charge into the media.

FIG. 2 is a simplified approximation of an energy diagram of the media of FIG. 1 showing a path of an injected charge through the media.

FIG. 3 is across-section of the system for storing information of FIG. 1 including the tip positioned in proximity to the media for ejecting a charge from the media.

FIG. 4 is a simplified approximation of an energy diagram of the media of FIG. 3 showing a path of an ejected charge through the media.

FIG. 5 is a cross-section of the system for storing information of FIG. 1 showing a signal represented by a plurality of charges detected in the media.

FIG. 6 is a cross-section of the system for storing information of FIG. 1 showing a signal represented by an absence of charges in the media.

### DETAILED DESCRIPTION

Scanning capacitance microscopy (SCM) is a method for direct imaging of submicron devices performed in an Atomic Force Microscope (AFM) with an ultrahigh frequency (UHF) resonant capacitance sensor connected by way of a transmission line to a grounded probe tip extending from a cantilever. The probe tip acts as a metal and a layer of insulting oxide is grown on top of a semiconductor sample to take advantage of characteristics of a metal-oxide semiconductor (MOS) structure. The probe tip-sample capacitance and variations in the capacitance load the end of the transmission line and change the resonant frequency of the system. The probe tip-sample capacitance can be probed by modulating carriers with a bias containing alternating current (AC) and direct current (DC) components. A quadrature lock-in amplifier is used to measure the capacitance sensor output with a high signal-to-noise ratio. The magnitude of the SCM output (dC/dV) signal is a function of carrier concentration.

SCM can operate in two different modes: differential capacitance mode (also referred to herein as open loop mode) and differential voltage mode (also referred to herein as closed loop mode). In open loop mode, an AC bias (e.g. 0.2-2Vpp, 10-100 kHz) is superimposed on a DC sample bias (e.g. −2 to 2V), and the probe tip is at a DC ground. The AC bias will alternatively deplete and accumulate the semiconductor surface. The change in capacitance is recorded using a lock-in technique. When large AC bias voltages are used, the measured value of the change in capacitance is the value across the current-voltage curve. When smaller AC bias voltage is used, the differential capacitance (dC/dV) is measured. When the tip is scanning over a lightly doped region, the spatial resolution is degraded. This is because it leads to a large depletion depth and a larger change in capacitance. Closed loop mode can provide a higher resolution for providing dopant profiles. In closed loop mode, the magnitude of the AC bias voltage applied to the sample is adjusted by a feedback loop to maintain a constant capacitance change. The capacitance or the depletion width is kept constant regardless of dopant density. A small bias is required for lightly doped area, which is easily depleted, and a high bias is required for highly doped area.

Embodiments of probe storage devices and methods of high density data storage in accordance with the present invention can include one or more probe tips (referred to herein as tips) adapted to electrically communicate with a surface of a media for writing and/or reading electric charges within the media. The media can comprise a charge-trapping material electrically isolated and accessible to the tip by way of tunneling. A charge-trapping material can preferably be a dielectric material that can hold stored charges and resist spontaneous leakage. The charge-trapping material preferably includes will-defined and high-density regions of trap sites for electrons and/or holes. Charge-trapping material can further comprise multiple different binary (e.g., SiₓN_{y}, AlₓO_{y}, AlₓN_{y}, HaₓO_{y}, TiₓO_{y}, etc.) or ternary materials (e.g., SiₓOₓN_{y} and etc.) of various stoichiometry. Various combinations of triple or double stacks of such dielectrics can further be employed as charge-trapping material based rewritable media.

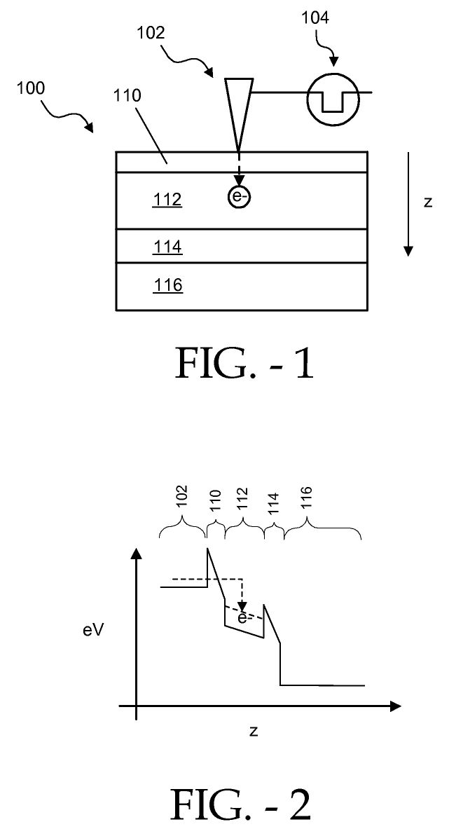

Referring to FIG. 1, a media 100 for use in an embodiment is shown comprising a barrier layer 110 including silicon dioxide (SiO₂) disposed over a trap layer 112 including silicon nitride (Si₃N₄). The top oxide should to thin enough to insure high-speed programming while thick enough to prevent from charge-leakage. The barrier layer 10 including silicon dioxide (also referred to herein as oxide) can be sufficiently thin to enable high-speed writing and can be thick enough to limit charge-leakage. In an embodiment, the barrier layer 110 can have a thickness of approximately one to two nanometers. The trap layer 112 including silicon nitride (also referred to herein as nitride) should have a sufficient thickness and uniformity to insure high storage capacity while having a sufficient thinners to provide low power consumption and high switching speed for reading and/or writing. Further, a voltage applied to a tip 102 to write information should be sufficiently high so that charges transport across the barrier layer 110 but sufficiently low to resist generating an oxide break down field. A three to five nanometers thick trap layer including nitride can include charge-traps in a density of approximately 3-5×10¹⁹/cm² at voltages in a range of three to five volts with a sub-microsecond switching speed. The trap layer 112 is disposed over an isolation layer 114 including oxide (or alternatively some other dielectric), which is disposed over a silicon substrate 116 (also referred to herein as a bottom electrode). The isolation layer 114 has a thickness of approximately four to six nanometers, although as will be appreciated the isolation layer 114 electrically isolates the trap layer 112 from the substrate 116 and therefore need only be as thick and uniform as necessary to achieve a desired electrical isolation. In alternative embodiments, a media for use with methods and systems of the present invention can comprise a different structure and/or different materials. For example, an isolation layer 114 can comprise some other dielectric, such as boro-phospho-silicate glass (BPSG), aluminum oxide, and hafnium oxide. Such materials can also be formed in place of the top oxide.

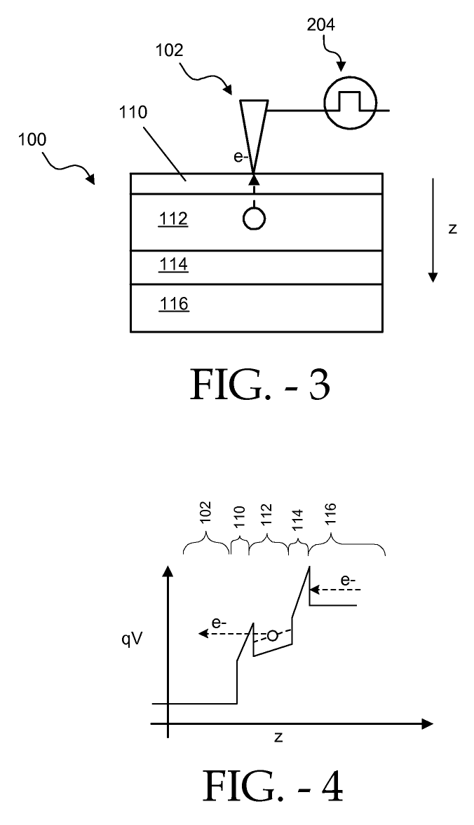

Information is written to the media by injecting charges, either electrons or holes, into the charge-traps of the trap layer 112 by way of the tip 102. Referring again to FIG. 1, a negative voltage pulse 104 applied to the tip 102 injects charges (e−) into the change traps in the trap layer 112. FIG. 2 is an energy diagram of the media showing a path z of an injected charge (e−) through the media 100. The impinging charges (e−) fall into a trap within the trap layer 112 when the charges (e−) encounter the lower energy state (eV) of the trap. When the voltage applied to the tip 102 is removed, high potential barriers of the barrier layer 110 and the isolation layer 114 resist escape of the trapped charges from escaping through the barrier layer 110 and the isolation layer 114, thereby providing nonvolatile storage of the charges. The trapped charge(s) can indicate an information state of “1” or “0”, depending on a convention applied. Traps in the trap layer 112 can be sufficiently separated to resist cross talk between adjacent traps. In an embodiment, a pitch of approximately six nanometers between charge traps can reduce cross talk between adjacent traps to a negligible amount. Referring to FIGS. 3 and 4, a trap can be returned to an initially neutral charge state by electric field-assisted ejection of the charge (e−). A sufficiently high voltage pulse 204 of reverse polarity is applied to the media 100 to cause removal of the charge (e−) from the trap. It should be noted that while charge injection/ejection (also referred to herein as writing/erasing) is described herein as occurring between a tip and the media, charge infection/ejection need not be achieved using a tip. In other embodiments charges can be injected and/or ejected from a bottom electrode only or from both sides by media engineering (for example by other combination of top and bottom oxide thickness). Further, wherein the tip and/or the bottom electrode is a semiconductor such as silicon, both electrons and holes can be charge sources. Silicon nitride includes trap sites for both electrons and holes. To more clearly communicate the present invention, embodiments including a media structure with a silicon bottom electrode with a relatively thick oxide layer over the bottom electrode and a tip extending from a cantilever (e.g., a platinum coated silicon cantilever) is described wherein electrons are the sole charge to write and erase a data bit.

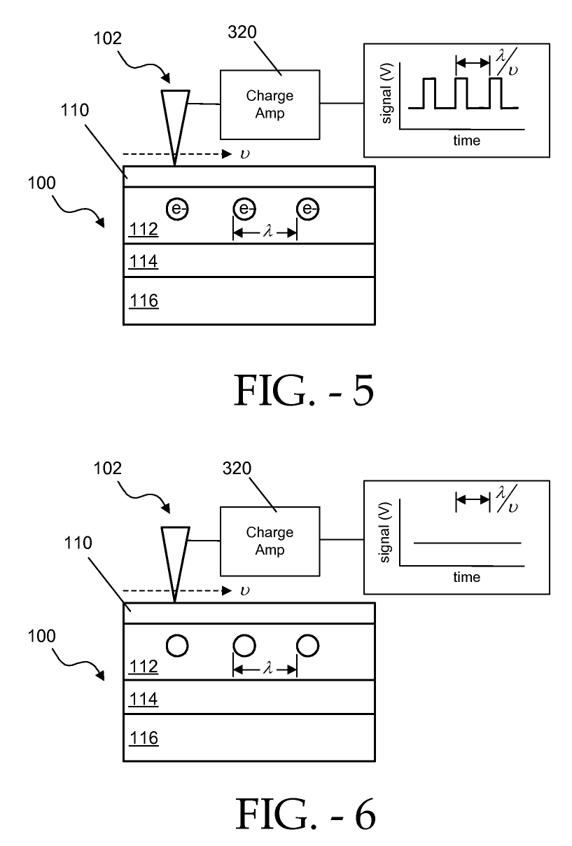

Information stored in the media in the form of trapped charges can be read as a digital bit signal corresponding to a voltage potential profile and/or a charge distribution. Systems in accordance with the present invention can measure properties of the capacitive structure (and/or electric field/potential distribution). Referring to FIG. 5, a tip 102 scans over the barrier layer 110 of the media 100 and a charge amplifier 320 associated with the tip 102 detects the potential profile and/or charge distribution at the surface induced by charges stored in the charge-traps within the trap layer 112. A charge amplifier 320 converts an input charge to a voltage output and need not rely on the lock-in technique of SCM to detect variations in dielectric constant. Further, the charge amplifier 320 enables a very high speed out scheme. Injecting charges (e−) into the trap layer 112 creates a potential difference to enable use of the charge amplifier 320 to measure the digital bit signal. The charge amplifier's signal profile reflects the arrangement of the charges stored in the trap layer 112. If the bits are written periodically, the charge amplifier 320 profiles a periodic pattern on the oscilloscope defined by bit-bit pitch λ and the read off speed v. as shown in FIG. 5. If the bits of FIG. 5 are erased by releasing the charges (e−) from the charge-traps the charge traps return to a neutral state and the charge amplifier profiles a flat line, as shown in FIG. 6.

The process of reading out a data bit by way of a charge amplifier allows the media and the tip to be held at a ground potential. As a result, a data bit is free from input disturbance and thus retains the stored information longer than conventional methods that rely on signal response to input perturbation such as DC voltage, AC voltage, current, light, etc., to read out the stored information.

Embodiments of systems and methods in accordance with the present invention can comprise a tip platform including a plurality of cantilevers extending from the tip platform, the plurality of tips platform including a plurality of cantilevers extending from the tip platform, can be associated with a media platform. One or both of the tip platform and the media platform can be movable so as to allow the tips to access an amount of the media desired given the number of tips employed. Systems and methods having suitable structures for positioning a media relative to a plurality of tips are described, for example, in U.S. patent application Ser. No. 11/553,435 entitled “Memory Stage for a Probe Storage Device”, filed Oct. 6, 2006 and incorporated herein by reference.

The foregoing description of the present invention has been presented for purposes of illustration and description. It is not intended to be exhaustive or to limit the invention to the precise forms disclosed. Many modifications and variations will be apparent to practitioners skilled in the art. The embodiments were chosen and described in order to best explain the principles of the invention and its practical application, thereby enabling others skilled in the art to understand the invention for various embodiments and with various modification as are suited to the particular use contemplated. It is intended that the scope of the invention be defined by the following claims and their equivalents.

1. A system for storing information, the system comprising:
a media including a barrier layer, an isolation layer and a trapping layer disposed between the barrier layer and the isolation layer; and
a tip adapted to inject a change through the barrier layer and into the trapping layer.

2. The system of claim 1, wherein the tip and the media are movable relative to one another.

3. The system of claim 1, wherein the tip is adapted to read a digital bit signal from a plurality of charges stored in the media.

4. The system of claim 3, further comprising:
a charge amplifier associated with the tip for detecting a voltage potential from the media.

5. The system of claim 3, further comprising:
a charge amplifier associated with the tip for detecting charge distribution from the media.

6. The system of claim 1, wherein the barrier layer comprises oxide.

7. The system of claim 6, wherein the barrier layer has a thickness substantially in the range of 1 to 2 manometers.

8. The system of claim 1, wherein the trapping layer comprises nitride.

9. The system of claim 8, wherein the trapping layer has a thickness substantially in the range of 3 to 5 manometers.

10. The system of claim 1, wherein the isolation layer comprises a dielectric.

11. The system of claim 10, wherein the isolation layer has a thickness of at least four nanometers.

12. The system of claim 1, wherein the tip is further adapted to eject a charge from the trapping layer.

13. The system of claim 2, further comprising:
a tip platform;
a plurality of cantilevers extending from the tip platform; and
a plurality of tips extending from corresponding cantilevers;
a media platform fixedly connected with the media;
wherein the media platform is positionable to allow the plurality of tips to access portions of the media.

14. A method of storing information in a media including a barrier layer, an isolation layer and a trapping layer disposed between the barrier layer and the isolation layer with a tip, the method comprising:
positioning the tip over the media so that the tip approximately contacts the barrier layer;
injecting a charge through the barrier layer and into the trapping layer.

15. The method of claim 14, further comprising:
repositioning the tip a predetermined pitch; and
injecting a second charge through the barrier layer and into the trapping layer.

16. The method of claim 15, wherein injecting a charge includes tunneling through the barrier layer.

17. The method of claim 15, further comprising detecting a voltage potential from the media with a charge amplified associated with the tip.

18. The method of claim 15, further comparing detecting a charge destruction form the media with a charge amplifier associated with the tip.

19. The method of claim 14, wherein injecting a charge further includes applying a negative pulse to the tip.

20. The method of claim 14, further comprising:
ejecting the charge by applying a positive pulse to the tip.
